(19) United States
(12) Patent Application Publication
(10) Pub. No.: US 2012/0182611 A1
(43) Pub. Date: Jul. 19, 2012

(54) THREE-DIMENSIONAL IMAGE DISPLAY APPARATUS

(76) Inventors: Rieko FUKUSHIMA, Tokyo (JP); Yuzo Hirayama, Yokohama-shi (JP)

(21) Appl. No.: 13/349,763

(22) Filed: Jan. 13, 2012

(30) Foreign Application Priority Data
Jan. 13, 2011 (JP) 2011-005307

(51) Int. Cl. G02B 27/22

(52) U.S. Cl. 359/462

(57) ABSTRACT

According to one embodiment, in a three-dimensional image display apparatus, a light-ray control unit is so arranged as to face a display unit. The light-ray control unit includes a plurality of optical apertures each having an extending direction. The optical apertures are substantially linearly extended along the extending direction and are substantially arranged in a direction normal to the extending direction. The extending direction is so inclined with respect to the second direction as to have an inclination angle which is selected within one of a first range from arctan(5+⅕) to arctan(5+⅖), a second range from arctan(5+⅗) to arctan(5+⅘), and a third range from arctan(6+⅕) to arctan(6+⅖).

### CROSS-REFERENCE TO RELATED APPLICATIONS

This application is based upon and claims the benefit of priority from prior Japanese Patent Application No. 2011-005307, filed Jan. 13, 2011, the entire contents of which are incorporated herein by reference.

### FIELD

Embodiments described herein relate generally to a three-dimensional image display apparatus for displaying a three-dimensional image.

### BACKGROUND

A three-dimensional image display apparatus which is a so-called three-dimensional display can display a moving picture image, and various systems are known about the three-dimensional display. In recent years, there is a demand for a system of the three-dimensional display, which is especially of a flat-panel type and does not require any dedicated spectacles. One of three-dimensional image display apparatuses of the type which does not require any dedicated spectacles is known as a system in which a light-ray control unit is mounted in front of a flat display panel which has pixels arranged at fixed positions, such as a direct-view type or projection type liquid crystal display device or a plasma display device. In this three-dimensional image display apparatus, the light-ray control unit controls light rays coming from the display panel and the controlled light rays are directed to a viewer so as to display a three-dimensional image in front of the viewer.

In this system, the light-ray control unit has a function of allowing a viewer to view different image segments depending on viewing angles even when the viewer views a same area on the light-ray control unit. More specifically, a slit array having parallax barriers or a lenticular sheet having cylindrical lens array is used as the light-ray control unit to provide a horizontal parallax (a right-and-left parallax). When not only the horizontal parallax but also a vertical parallax (an up-and-down parallax) is provided, a pinhole array or lens array is used as the light-ray control unit.

The system using the light-ray control unit is further classified into a binocular system, multi-view system, super-multi-view system (a multi-view system under super-multi-view conditions), and integral imaging (to be also referred to as II hereinafter) system. The binocular system allows stereoscopic viewing based on a binocular parallax. Three-dimensional images of the multi-view system and subsequent systems are called three-dimensional images to be distinguished from a stereoscopic image of the binocular system, since they include a motion parallax to various degrees. The basic principle required to display these three-dimensional images is substantially the same as the integral photography (IP) principle, which was invented about 100 years ago and is applied to a three-dimensional photography.

Of these systems, the II system has a feature that viewpoint positions have high degrees of freedom to allow easy stereoscopic viewing. With a one-dimensional II system which gives only a horizontal parallax without any vertical parallax, a display device with a high resolution can be relatively easily implemented, as described in SID04 Digest 1438. By contrast, in a binocular system or multi-view system, by limiting viewpoint positions that allow stereoscopic viewing, since a resolution can be easily increased compared to the one-dimensional II system, and a three-dimensional image can be generated based on only images acquired from the viewpoint positions, a load on image generation becomes lighter. However, there is a problem that an image is not easy to view since the viewpoint positions are limited.

Such direct-view and naked-eye type three-dimensional display apparatus using the parallax barriers suffers a problem of generation of any moiré or false color due to optical interferences between a periodic structure in one direction of the parallax barriers and non-display portions which are formed in a matrix on a two-dimensional display device to separate pixels or a periodic structure of a color arrangement of pixels in a horizontal direction (first direction). As a measure against such problem, a system and a method are proposed in U.S. Pat. No. 6,064,424, wherein the light-ray control unit has a periodicity in a predetermined direction, and the predetermined direction makes a certain angle with a direction in which a pixel periodicity of the flat display is given, so that the parallax barriers are obliquely arranged in the system. However, by only obliquely arranging the parallax barriers, moiré cannot be completely eliminated. Hence, there is also proposed a method of eliminating moiré in JP-A 2005-86414 (Kokai), in which diffusion light components are added in parallax information. However, since this method worsens separation of parallax information, an image quality drop is inevitable.

As described above, in the conventional three-dimensional image display apparatus which combines the light-ray control unit whose periodicity is limited to one direction, and the two-dimensional display device on which pixels are arranged in a matrix, luminance non-uniformity (moiré) is generated since the periodicity of the light-ray control unit and that in the first direction on the two-dimensional display device interfere with each other. As a method of eliminating moiré, a method of making an angle between the direction of the periodicity of the light-ray control unit and that of the periodicity of pixels, that is, a method of obliquely arranging the light-ray control unit is available. However, even with this method, moiré cannot be completely eliminated depending on tilt angles.

### BRIEF DESCRIPTION OF THE DRAWINGS

FIG. 1 is an explanatory view showing a partially enlarged display unit in a three-dimensional image display apparatus for displaying a two-dimensional image according to a comparative embodiment, in which a direction of a parallax barrier is matched with a vertical arranging direction of pixels;

FIG. 2 is a graph showing a luminance change when a viewing angle is changed in the display apparatus shown in FIG. 1;

FIG. 3 is an explanatory view showing a partially enlarged display unit in a three-dimensional image display apparatus for displaying a two-dimensional image according to an another comparative embodiment, in which a elongated direction of a light-ray control unit make an angle of arctan(⅓) with the vertical arranging direction of pixels;

FIG. 4 is a graph showing a luminance change when a viewing angle is changed in the display apparatus shown in FIG. 3;

FIG. 5A is an explanatory view showing a partially enlarged display unit in a three-dimensional image display apparatus according to an explanatory embodiment, in which a elongated direction of a light-ray control unit make an angle of arctan(¼) with the vertical arranging direction of pixels;

FIG. 5B is a graph showing a luminance change when a viewing angle is changed in the display apparatus shown in FIG. 5A;

FIG. 6A is an explanatory view showing a partially enlarged display unit in a three-dimensional image display apparatus according to an another explanatory embodiment, in which a elongated direction of a light-ray control unit make an angle of arctan(⅕) with the vertical arranging direction of pixels;

FIG. 6B is a graph showing a luminance change when a viewing angle is changed in the display apparatus shown in FIG. 6A;

FIG. 7A is an explanatory view showing a partially enlarged display unit in a three-dimensional image display apparatus according to a yet another explanatory embodiment, in which a elongated direction of a light-ray control unit make an angle of arctan(⅙) with the vertical arranging direction of pixels;

FIG. 7B is a graph showing a luminance change when a viewing angle is changed in the display apparatus shown in FIG. 7A;

FIG. 8A is an explanatory view showing a partially enlarged display unit in a three-dimensional image display apparatus according to a yet another explanatory embodiment, in which a elongated direction of a light-ray control unit make an angle of arctan( 1/7) with the vertical arranging direction of pixels;

FIG. 8B is a graph showing a luminance change when a viewing angle is changed in the display apparatus shown in FIG. 8A;

FIG. 9 is an explanatory view showing the relationship between values n according to the explanatory embodiments and moiré generation states; and

FIG. 10 is a schematic perspective view showing a configuration of a three-dimensional image display apparatus to which the embodiments are applied.

### DETAILED DESCRIPTION

Various embodiments will be described hereinafter with reference to the accompanying drawings.

In general, according to an embodiment, there is provided a three-dimensional image display apparatus comprising:

a display unit including a plurality of sub pixels arranged in an array of rows in a first direction and columns in a second direction, and

a light-ray control unit facing to the display unit and includes a plurality of optical apertures extending along an extending direction substantially linearly and arranged in a direction substantially normal to the extending direction, and the extending direction is so inclined with respect to the second direction as to have an inclination angle being within one of a first range from arctan(5+⅕) to arctan(5+⅖), a second range from arctan(5+⅗) to arctan(5+⅘), and a third range from arctan(6+⅕) to arctan(6+⅖).

Also, according to an another embodiment, there is provided a three-dimensional image display apparatus comprising:

a three-dimensional image display apparatus comprising:

a display unit including a plurality of sub pixels arranged in an array of rows in a first direction and columns in a second direction, and

a light-ray control unit facing to the display unit and includes a plurality of optical apertures extending along an extending direction substantially linearly and arranged in a direction substantially normal to the extending direction, and an actual aperture width are substantially matched with a period of a luminance change of light rays under an assumption that an aperture is infinitely small.

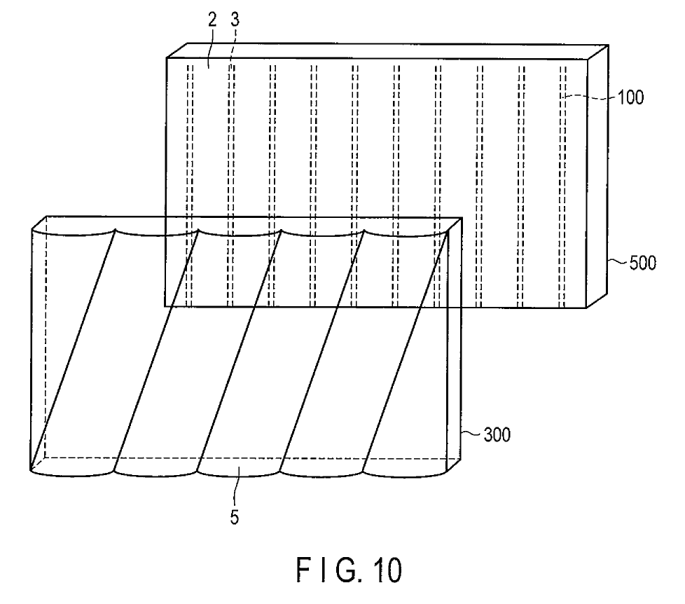

FIG. 10 shows a three-dimensional image display apparatus according to the aforementioned embodiment. This three-dimensional image display apparatus 500 has a configuration which is a so called an II (Integral Imaging) system, and includes a two-dimensional image display device (so-called two-dimensional image display panel) 100 which displays a two-dimensional image so as to allow the user to view a three-dimensional image according to the II system. A lenticular sheet 300 having a parallax barrier lens array (i.e., a cylindrical lens array) which acts as a light-ray control unit 5 are arranged on the entire surface of this two-dimensional image display device 100, and light rays coming from the two-dimensional image display device 100 are controlled by these light-ray control unit (light-shielding barriers or parallax barriers) 5 to be directed toward a viewer (not shown). When the viewer visually observes light rays with naked eyes, which are selectively guided from the light-ray control unit 5, the viewer can view a three-dimensional image in front of (or behind) the three-dimensional image display apparatus.

In this embodiment, the two-dimensional image display device 100 includes a display panel which displays a two-dimensional image. The display panel has sub pixels arranged in a matrix, on which unit images required to display a three-dimensional image are so distributed as to constitute the two-dimensional image. The two-dimensional image display device 100 may be a direct-view type liquid crystal display device, a projection type liquid crystal display device, a plasma display device, a field emission display device, an organic EL display device, or the like as long as it includes such display panel. The light-ray control unit 5 is configured as a slit array sheet having a slit array or a lenticular sheet having a lens array (a cylindrical lens array) which is arranged to have a periodicity in a horizontal direction (a second direction), and substantially extends along a vertical direction (a first direction). In such three-dimensional image display apparatus, the two-dimensional image display device 100 displays the unit images to provide a parallax in the horizontal direction (the second direction), and light rays coming from the unit images are incident in the light-ray control unit 5 which is substantially arranged in the horizontal direction (the second direction). The light-ray control unit 5 controls the light rays and guides the controlled light rays to the viewer in such a manner that the viewer can observe the three dimensional image.

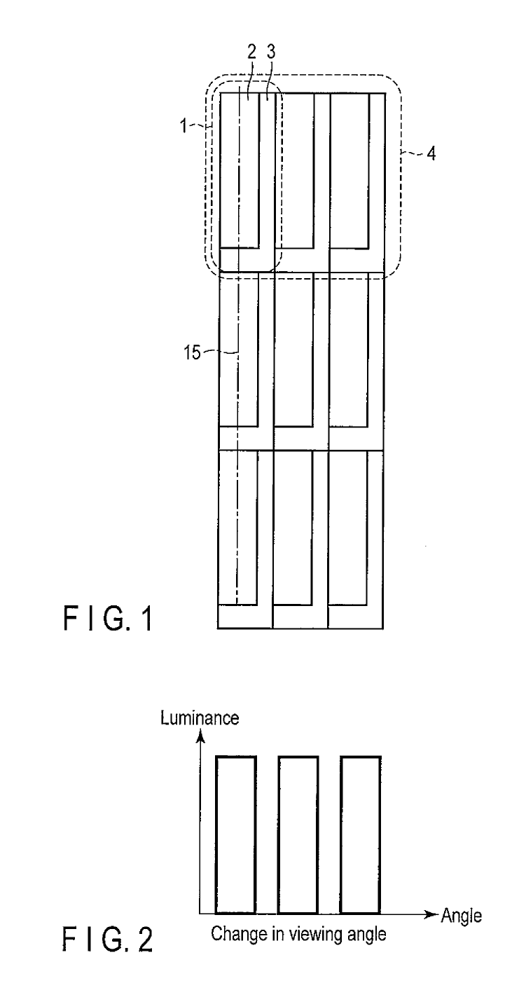

FIG. 1 is a schematic enlarged view of pixels 4 of the display unit (display panel) 100 which displays a two-dimensional image in the three-dimensional image display apparatus according to the comparative embodiment.

The display unit 100 has a matrix array of sub pixels 1 which are arranged in a matrix in the horizontal and vertical directions. Each sub pixel 1 is formed of an aperture 2 and a light-shielding portion 3. The sub pixel 1 is formed into a rectangle (rectangular shape), the lengths of the sides of which have a ratio of 1:3 (short side:long side), and three sub pixels 1 are juxtaposed in the second direction to form a pixel. In each pixel of this display unit 100, color filters are respectively arranged on the three sub pixels so as to display R (red), G (green), and B (blue). Light rays emitted from a backlight (not shown) pass through this aperture 2 to be converted into those whose color is determined to be one of R, G, and B, and are radiated in a space in front of the display unit. Then, these light rays pass through the light-ray control unit 5 to be converted into light rays for displaying a three-dimensional image. In FIG. 1, a ridge or an elongated axis of each light-ray control unit 5 is indicated by a broken line 15. Each sub pixel 1 has the aperture 2 through which light rays are output, and the light-shielding portion (corresponding to a so-called black stripe) 3 which surrounds this aperture 2 to shield light rays.

As has been described in the related art, in a structure in which the arranging direction of the light-ray control unit 5 and the arranging direction of the apertures of the sub pixels 1 are matched, the ratio of the apertures 2 which are viewed via the light-ray control unit 5 varies depending on viewing angles, and a luminance change (moiré) may be generated. That is, luminance levels may considerably change upon changing the angle, and FIG. 2 illustrates this relationship between the luminance levels and the viewing angle.

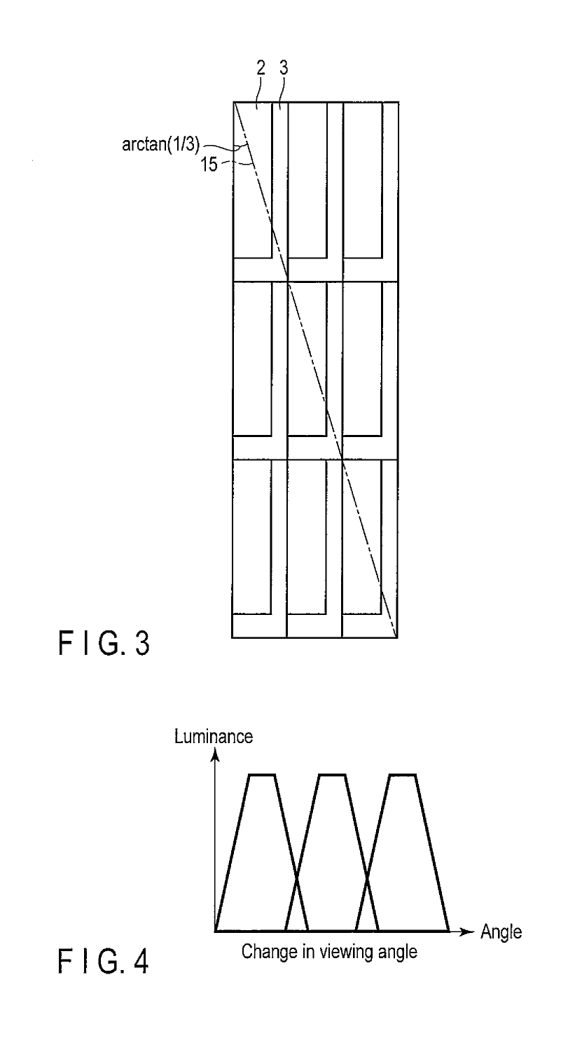

In a structure in which the arranging direction of the light-ray control unit 5 and the arranging direction of the apertures of the sub pixels 1 make an angle, as described in the related art, the luminance change (moiré) can be suppressed, but it is revealed that the suppression effect is limited. FIG. 3 illustrates a case in which an angle between the ridge 15 or the elongated axis of the light-ray control unit 5 and the vertical direction of pixels of the display unit 100 make is set to be arctan(⅓). By making a certain angle (n) in this way, although the variation of the ratio of the apertures which are viewed via the light-ray control unit 5 is suppressed, a luminance change (a sum of luminance levels from respective sub pixels) remains, as shown in FIG. 4.

To make further consideration, since each sub pixel 1 is a rectangle, the lengths of the sides of which are 1:3, and the tilt of the light-ray control unit 5, that is, the angle the ridge 15 or the elongated axis of the light-ray control unit 5 and the vertical direction of pixels of the display unit make, is set to be arctan(⅓), luminance change phases match in first to third pixel rows shown in FIG. 3.

As can be understood from the above result, tilting the light-ray control unit is effective to suppress luminance non-uniformity (moiré) but moiré cannot be perfectly eliminated by only tilting the light-ray control unit. Based on the above consideration, phases have to be shifted for respective pixel rows (to eliminate the periodicity of positions which are viewed via the light-ray control unit). Letting arctan (1/n) be an angle between the ridge 15 of the light-ray control unit and the vertical direction of pixels of the display unit, the periodicity can be set to be highest when n assumes an integer value, and can be reduced when n does not assume an integer value. For example, cases in which n assumes an integer value and it does not assume an integer value will be explained. In the following explanation, in formula (n+b/a), “n”, “a”, and “b” are integers, and a relation of (a<b) is established. In the following examples, “a” assumes 2, 3, 4, and 5.

n=integer value

(n+b/a)=integer value+½

(n+b/a)=integer value+⅓

(n+b/a)=integer value+¼

(n+b/a)=integer value+⅕

. . .

On the other hand, merits obtained when “n” assumes an integer value (b/a=0) can decrease a formation load for three-dimensional display image information, and can achieve a high image quality. In order to produce images required to display a three-dimensional image, multi-viewpoint images captured from different angles are prepared, are decomposed for respective pixels, and are laid out on sub pixel groups behind the light-ray control unit, so as to allow the viewer to view pixel information according to a viewing angle. The highest efficiency is assured when the multi-viewpoint images match sampling points of pixels viewed via the light-ray control unit. In general image formats as well as those of the multi-viewpoint images, the vertical direction and vertical sampling direction are perpendicular to each other, and sampling intervals are equal to each other. However, when the optical apertures of the light-ray control unit are tilted, sampling position mis-matches are caused. For this reason, image processing for re-sampling the multi-viewpoint images according to the sampling positions of the light-ray control unit is added. This increases the generation load of the three-dimensional image display image information, and provokes an image quality drop. Even in such case, when “n” assumes an integer value, sampling matching portions are periodically generated. That is, high periodicity also means suppression of an image quality drop.

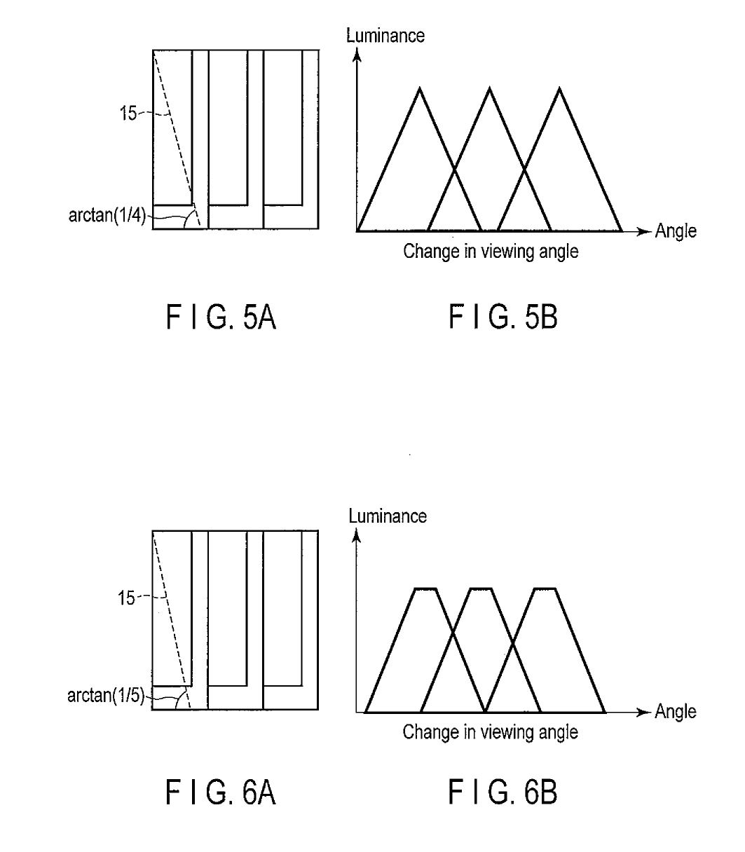

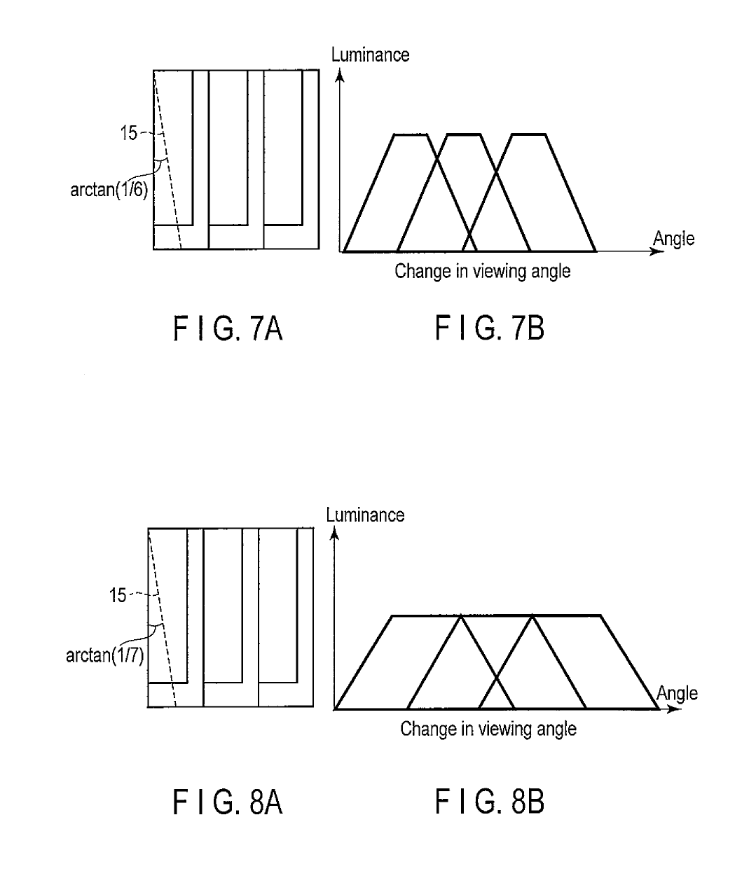

Finally, a crosstalk amount between pieces of pixel information will be described below. FIGS. 5B, 6B, 7B, and 8B respectively show changes in ratio of apertures viewed via the light-ray control unit 5 when the angle the ridge 15 of each light-ray control unit and the vertical direction of pixels of the display unit make is set to be arctan(¼), arctan(⅕), arctan(⅙), and arctan( 1/7), respectively, as shown in FIGS. 5A, 6A, 7A, and 8A. In FIG. 2, pieces of pixel information viewed according to a change in viewing angle are completely separated. This means that switching to a side surface of a three-dimensional image discontinuously occurs. That is, by tilting the light-ray control unit 5, pieces of neighboring pixel information (parallax information) can be continuously switched. Hence, a three-dimensional image which is smoothly switched to an image of a side surface according to a viewing angle can be provided. However, when an excessive tilt angle is set, for example, parallax images which neighbor to sandwich one image between them are mixed, as shown in FIG. 8B, and parallax images are incompletely separated in turn. This also causes an image quality drop of a three-dimensional image.

To summarize the aforementioned analysis and consideration results, the relationship among the sampling periodicity, an elimination effect of moiré, image quality, and an image processing load upon tilting the parallax barrier is as shown in Table 1 below. This Table 1 additionally describes how moiré is viewed in practice.

TABLE 1

| Tilt of parallax | | | | Image | |
|---|---|---|---|---|---|
| barrier | Period- | | Image | processing | |
| (arctan (n + b/a)) | icity | Moiré | quality | load | Crosstalk |
| n = integer value, | High | Generated | High | Low | 5 < (n + |
| b/a = 0 | | | | | b/a) < 6 |
| n = integer value, | ↑ | Generated | ↑ | ↑ | |
| b/a = ½ | | | | | |
| n = integer value, | \| | Generated | \| | [ | |
| b/a = ⅓ | | palely | | | |
| n = integer value, | ↓ | Visual | ↓ | ↓ | |
| b/a = ¼ | | limitation | | | |
| n = integer value, | Low | or less | Low | High | |
| b/a = ⅕ | | | | | |

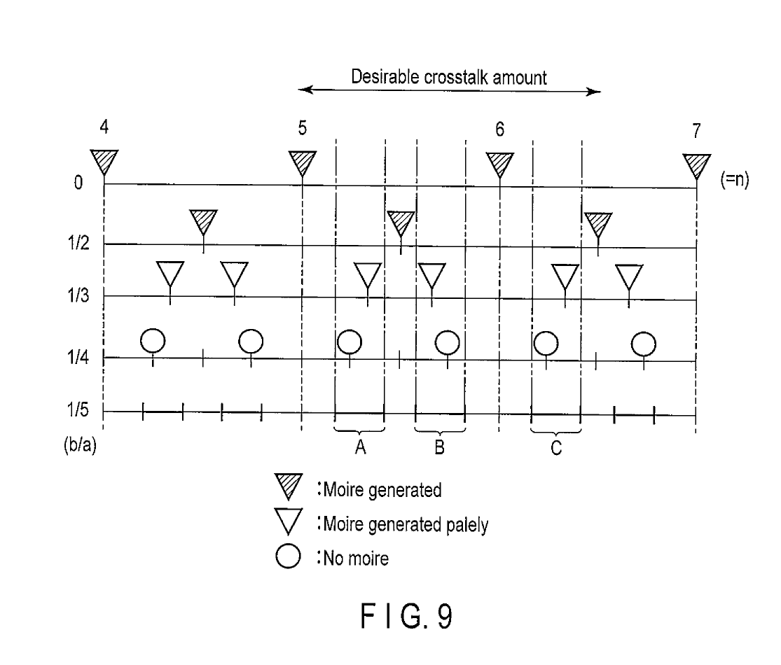

As can be seen from this Table 1, as a moiré suppression range having an appropriate crosstalk amount, the following ranges excluding “n=integer value”, “n=integer value+½”, and their neighboring values (values indicated by triangular arrows (hatched triangular arrows) of moiré generation in FIG. 9) are set.

5+⅕≦(n+b/a)≦5+⅖(range A in FIG. 9)

5+⅗≦(n+b/a)≦5+⅘(range B in FIG. 9)

6+⅕(n+b/a)≦6+⅖(range C in FIG. 9)

When importance is attached to suppression of moiré to a visual limitation or less (values indicated by open circles indicating no moiré in FIG. 9) even within these ranges excluding the above values, it is preferable to select one of:

(n+b/a)=5+¼

(n+b/a)=5+¾

(n+b/a)=6+¼

On the other hand, when importance is attached to suppression of an image quality drop and an increase in image processing load, it is particularly effective to select a tilt from:

(n+b/a)=5+⅓

(n+b/a)=5+⅔

(n+b/a)=6+⅓

At this time, since a luminance variation remains, pale moiré is generated. However, when the period of the luminance variation and an aperture width of the light-ray control unit (an aperture width in case of a barrier or a spot size in case of a lens) are matched, such moiré can be suppressed. However, since a transparency has to be considered in case of a finite viewing distance, a region viewed from apertures is varied according to the viewing distance. Hence, the moiré suppression method by means of the aperture width of the light-ray control unit is not a perfect method. However, that method is effective to eliminate pale moiré.

With the aforementioned method, in the three-dimensional image display apparatus in which the light-ray control unit are vertically set, moiré, an image quality drop, and an increase in image processing load as display disturbances can be suppressed, and a smooth motion parallax can be realized by an appropriate crosstalk amount, thus improving the total image quality of a three-dimensional image.

According to the above embodiment or example, in a three-dimensional image display apparatus in which light-ray control unit, periodicity of which is limited to one direction, and a two-dimensional display device on which pixels are arranged in a matrix in a first direction and second direction perpendicular to the first direction (vertical and horizontal directions) are combined, the three-dimensional image display apparatus which can eliminate moiré without causing any image quality drop can be provided.

As described above, according to this embodiment, in the three-dimensional image display apparatus in which the light-ray control unit, periodicity of which is limited to one direction, and the two-dimensional display device are combined, the three-dimensional image display apparatus which eliminates moiré and suppresses any image quality drop by controlling a tilt of the light-ray control unit can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A three-dimensional image display apparatus comprising:
a display unit including a plurality of sub pixels arranged in an array of rows in a first direction and columns in a second direction, and
a light-ray control unit facing to the display unit and includes a plurality of optical apertures extending along an extending direction substantially linearly and arranged in a direction substantially normal to the extending direction, and the extending direction is so inclined with respect to the second direction as to have an inclination angle being within one of a first range from arctan(5+⅕) to arctan(5+⅖), a second range from arctan(5+⅗) to arctan(5+⅘), and a third range from arctan(6+⅕) to arctan(6+⅖).

2. The apparatus of claim 1, wherein the inclination angle is set to be one of arctan(5+¼) within the first range, arctan(5+¾) within the second range, and arctan(6+¼) within the third range.

3. The apparatus of claim 1, wherein the inclination angle is set to be one of arctan(5+⅓) within the first range, arctan(5+⅔) within the second range, and arctan(6+⅓) within the third range.

4. A apparatus comprising:
a three-dimensional image display apparatus comprising:
a display unit including a plurality of sub pixels arranged in an array of rows in a first direction and columns in a second direction, and
a light-ray control unit facing to the display unit and includes a plurality of optical apertures extending along an extending direction substantially linearly and arranged in a direction substantially normal to the extending direction, and an actual aperture width are substantially matched with a period of a luminance change of light rays under an assumption that an aperture is infinitely small.
